(19) United States
(12) Patent Application Publication
(10) Pub. No.: US 2026/0105211 A1
(43) Pub. Date: Apr. 16, 2026

(54) OPTIMIZATION METHOD FOR ARRANGEMENT OF PRESSURE SENSORS IN URBAN GAS PIPELINE NETWORK AND SYSTEM THEREOF

(71) Applicant: NORTH CHINA MUNICIPAL ENGINEERING DESIGN & RESEARCH INSTITUTE CO, LTD., Tianjin (CN)

(72) Inventors: Wenxue GAO, Tianjin (CN); Yingjie HU, Tianjin (CN); Rongsong YAN, Tianjin (CN); Yan WANG, Tianjin (CN); Lin YANG, Tianjin (CN); Mingchang YANG, Tianjin (CN); Qingwei MIAO, Tianjin (CN)

(21) Appl. No.: 19/310,249

(22) Filed: Aug. 26, 2025

(30) Foreign Application Priority Data
Oct. 15, 2024 (CN) 2024114338303

(51) Int. Cl. G06F 30/20; G06F 111/10; G06F 113/14; G06F 119/14

(52) U.S. Cl. CPC G06F 30/20; G06F 2111/10; G06F 2113/14; G06F 2119/14

(57) ABSTRACT

The present disclosure discloses an optimization method and system for arrangement of pressure sensors in an urban gas pipeline network. The optimization system includes a pipeline network simulation unit, an index calculation unit, a significance calculation unit, a node comparison unit, and a node optimization unit. Pressure variation of all nodes and regulating stations of the pipeline network during leakage at each node or regulating station is simulated by gas pipeline network simulation software, leakage monitoring coverage range quantities, leakage monitoring sensitivities, operating pressure and operating flow of different nodes and regulating stations are calculated, indices of pipeline ages and region grades are introduced, significance of each node and regulating station is calculated, the nodes are screened and optimized, and optimized arrangement points of the pressure sensors are determined.

### CROSS-REFERENCE TO RELATED APPLICATION

This application claims priority from the Chinese patent application 2024114338303 filed Oct. 15, 2024, the content of which is incorporated herein in the entirety by reference.

### TECHNICAL FIELD

The present disclosure relates to a safety optimization method for an urban gas pipeline network, in particular to an optimization method for arrangement of pressure sensors in an urban gas pipeline network and system thereof.

### BACKGROUND ART

By installing wireless pressure sensors at key nodes of gas pipelines, node pressure variation can be monitored in real time on a gas supervisory control and data acquisition (SCADA) monitoring system platform, which is of great significance for ensuring safe operation of an urban gas pipeline network. However, due to the large number of nodes in the urban pipeline network, it will cost a lot if each node is arranged with a pressure sensor. Therefore, when considering operating condition of pipelines, it is very important to arrange pressure sensors in a way that takes cost and monitoring efficiency into account.

CN113094853A provides an optimized layout method and system for leakage positioning of a gas pipeline network. According to the method, the minimum number value of required pressure sensors and necessary sensor point position combinations are obtained based on evaluation indices, and the minimum number value of the required pressure sensors and point position arrangement of the pressure sensors can be obtained under the condition that leakage identification events are not lost.

CN110657352A provides a gas pipeline monitoring point arrangement optimization method and system, a device and a storage medium. The method analyzes underground space of all inspection wells along gas pipelines, searches node positions taking construction cost and monitoring efficiency into account based on an effective monitoring length, so as to effectively select the underground space where monitoring sensors need to be arranged, and corresponding node positions can be provided according to the requirements for detection efficiency, thereby reducing blindness of point position selection.

CN113473501A provides an optimization method applied to arrangement of leakage detectors and pressure sensors in a gas pipeline network. The method optimizes an arrangement of a sensor group based on a Levy flight mechanism. By means of an optimized solution, the method avoids local limits in the existing optimization method, and reduces cost of hardware devices and redundancy of monitoring data.

It can be shown that in the existing patents, positions of pressure sensors in a gas pipeline network are optimized by adopting different methods. Considering factors such as economical efficiency, efficiency and coverage range of arrangement, the number and positions of the pressure sensors are determined. However, the above methods are in lack of consideration of an actual operating condition of the urban gas pipeline network. For example, only a topological relation of the pipeline network is considered, while pressure grades of different pipeline networks are ignored. Transmission and arrangement pipelines should be classified into ultra-high pressure, high pressure, sub-high pressure, medium pressure and low pressure pipelines according to maximum working pressure, and the pressure sensors have different sensitivities to leakage of pipelines with different pressure grades. Moreover, gas pipelines with different pressure grades are connected through pressure regulating apparatuses. Usually, pressure monitoring apparatuses are arranged on sides of the pressure regulating apparatuses to determine whether the pressure regulating apparatuses work normally. That is, there are inherent pressure sensors between the gas pipelines with different pressure grades, and these sensors are necessary and cannot be considered as optimized sensors. Meanwhile, in the methods provided in the existing patents, influences of leakage probabilities and consequences of the gas pipelines on the arrangement of the pressure sensors are not considered. Usually, the leakage probability of old gas pipelines is higher than that of new gas pipelines, and the consequences of gas leakage occurring in first-grade regions are higher than those in fourth-grade regions. That is, most of the optimization methods for the arrangement of the pressure sensors provided in the existing patents aim at new pipeline networks, without considering the arrangement optimization on existing old pipelines, as well as without taking actual operating characteristics of the pipelines such as pressure, flow, and pipeline age into account, resulting in the inability to providing priorities and optimization methods for the arrangement of the pressure sensors in actual renovation and reconstruction of the old pipeline networks.

### SUMMARY OF THE INVENTION

The present disclosure aims at providing an optimization method for arrangement of pressure sensors in an urban gas pipeline network and system thereof to overcome the defects in the prior art. The operation method and system are realistic and easy to operate.

An optimization method for arrangement of pressure sensors in an urban gas pipeline network according to the present disclosure includes the following steps:
step 1, adopting n nodes and regulating stations in the urban gas pipeline network as to-be-optimized points, respectively numbering and naming the same as A₁, A₂, . . . , Aᵢ, . . . , Aₙ; inputting information of each pipeline in the urban gas pipeline network in a gas pipeline network simulation software, and simulating and outputting operating pressure P and operating flow Q of each to-be-optimized point of the actual gas pipeline network under a normal operating condition; setting a leakage flow value ΔQ at each to-be-optimized point, simulating and outputting a self pressure variation value of each to-be-optimized point of the actual gas pipeline network during leakage and pressure variation values of other to-be-optimized points influenced by leakage, and recording as [ΔP^{Ai}_{A1}, ΔP^{Ai}_{A2}, . . . , ΔP^{Ai}_{Ai}, ΔP^{Ai}_{Aj}, . . . , ΔP^{Ai}_{An}], where ΔP^{Ai}_{Ai} represents the self pressure variation value of the to-be-optimized point Aᵢ during leakage, and ΔP^{Ai}_{Aj} represents the pressure variation value of Aⱼ during leakage of the to-be-optimized point Aᵢ; representing the pressure variation values of all the to-be-optimized points as a matrix [T]_{n×n} during leakage of each to-be-optimized point:

$$T = \{ \begin{matrix}Δ {P}_{A 1}^{A 1} & Δ {P}_{A 2}^{A 1} & … & Δ {P}_{A n}^{A 1} \\ Δ {P}_{A 1}^{A 2} & Δ {P}_{A 2}^{A 2} & … & Δ {P}_{A n}^{A 2} \\ … & … & … & … \\ Δ {P}_{A 1}^{A n} & Δ {P}_{A 2}^{A n} & … & Δ {P}_{A n}^{A n}\end{matrix} \} = \{ \begin{matrix}{t}_{11} & {t}_{12} & … & {t}_{1 n} \\ {t}_{21} & {t}_{22} & … & {t}_{2 n} \\ … & … & … & … \\ {t}_{n 1} & {t}_{n 2} & … & {t}_{n n}\end{matrix} \} ;$$

where tᵢⱼ is an element in an i^{th} row and a j^{th} column in the matrix [T]_{n×n}, tᵢⱼ=ΔP^{Ai}_{Aj}, and i, j=1, 2, 3, . . . , n;
step 2: calculating index values of a leakage monitoring coverage range quantity N, a leakage monitoring sensitivity S, operating pressure P, operating flow Q, a pipeline age Y, and a region grade G of each to-be-optimized point, specifically as follows:
S201: calculating the leakage monitoring coverage range quantity N of each to-be-optimized point, where a solving process of the leakage monitoring coverage range quantity N is as follows:
firstly, calculating a pressure influence coefficient matrix [Y]_{n×n} of leakage of each to-be-optimized point for other to-be-optimized points according to the matrix [T]_{n×n} in step 1, where a calculation formula for an element Y(i, j) in an i^{th} row and a j^{th} column in the pressure influence coefficient matrix [Y]_{n×n} is Y(i, j)=tⱼᵢ/tⱼⱼ=ΔP^{Aj}_{Ai}/ΔP^{Aj}_{Aj}; i=1, 2, 3, . . . , n, j=1, 2, 3, . . . , n, and n is the number of all the to-be-optimized points; an element of a vector in the i^{th} row in the matrix [Y]_{n×n} represents an influence degree to which the pressure of the to-be-optimized point Aᵢ is affected by the leakage of other to-be-optimized points; and an element of a vector in the j^{th} column represents an influence degree to which the pressure of other to-be-optimized points is affected by the leakage of the to-be-optimized point Aⱼ;
secondly, standardizing a standard deviation of each element in a k^{th} column in the matrix [Y]_{n×n} through a standard deviation standardizing method, to obtain a pressure influence standard matrix [Y′]_{n×n};
thirdly, standardizing extreme values of elements in each column in the matrix [Y′]_{n×n} through an extreme value standardizing method, to obtain a pressure influence extreme value standard matrix [Y″]_{n×n};
fourthly, calculating the matrix [Y″]_{n×n} through a Euclidean distance method, to obtain a leakage pressure influence fuzzy similar matrix [R]_{n×n};
fifthly, setting a pressure correlation distance constraint value μ of the to-be-optimized points, comparing all elements in [R]_{n×n} and the correlation distance constraint value μ, in a case that an element rᵢⱼ in [R]_{n×n} is less than or equal to μ, converting the element into 1, otherwise, converting the element into 0; converting the leakage pressure influence fuzzy similar matrix [R]_{n×n} into a Boolean matrix [r]_{n×n}; where μ is greater than 0 and less than 1; rᵢⱼ is an element in an i^{th} row and a j^{th} column of the leakage pressure influence fuzzy similar matrix [R]_{n×n}, and i, j=1, 2, 3, . . . , n; the magnitude of rᵢⱼ reflects a similarity between elements in an i^{th} row in the matrix [Y′″]_{n×n} and elements in a j^{th} column in the matrix [Y″]_{n×n}, namely pressure correlation between the to-be-optimized points Aᵢ and Aⱼ;
sixthly, summing the Boolean matrix [r]_{n×n} row by row, to obtain the leakage monitoring coverage range quantity N of each to-be-optimized point as a pressure monitoring point;
S202: calculating the leakage monitoring sensitivity S of each to-be-optimized point;
multiplying an element Y″(i, j) in the pressure influence extreme value standard matrix [Y″]_{n×n} and a corresponding element r(i, j) in the Boolean matrix [r]_{n×n}, to obtain a matrix [S]_{n×n}, and summing the matrix [S]_{n×n} row by row, to obtain the leakage monitoring sensitivities S of to-be-optimized points as pressure monitoring points;
S203: reading the operating pressure P of each to-be-optimized point under the normal operating condition output in step 1;
S204: reading the operating flow Q of each to-be-optimized point under the normal operating condition output in step 1;
S205: determining a pipeline age Y of a pipeline where each to-be-optimized point is located through a gas company pipeline installation completion acceptance record or a gas information management platform;
S206: determining a region grade G of the pipeline where each to-be-optimized point is located through a gas pipeline network geographic information system, the gas information management platform or manual inspection, and setting G as 1, 2, 3 and 4 in a case of a first-grade region, a second-grade region, a third-grade region and a fourth-grade region respectively;
step 3, calculating significance of each to-be-optimized point through a CRITIC method of weighting; and
step 4, screening and optimizing the to-be-optimized points, to obtain optimized arrangement points of the pressure sensors.

An optimization system for arrangement of pressure sensors in an urban gas pipeline network according to the present disclosure includes the following units:
a pipeline network simulation unit configured to simulate pressure and flow of each to-be-optimized point of the actual gas pipeline network under a normal working condition;
and set a leakage flow value at each to-be-optimized point, and simulate and output a self pressure variation value of each to-be-optimized point of the actual gas pipeline network during leakage and pressure variation values of other nodes and regulating stations influenced by leakage;
an index calculation unit configured to calculate index values of a leakage monitoring coverage range quantity N, a leakage monitoring sensitivity S, operating pressure P, operating flow Q, a pipeline age Y, and a region grade G of each to-be-optimized point;
a significance calculation unit configured to calculate significance of each to-be-optimized point through a CRITIC method of weighting; and
node comparison and optimization units configured to sort according to degrees of significance of the to-be-optimized points, screen and optimize the to-be-optimized points, and output optimized arrangement points of the pressure sensors.

The present disclosure has following beneficial effects:
1. according to the method, the information of the urban gas pipeline network can be monitored to the maximum degree, the problems of single-objective consideration has a single factor and a calculation process of multi-objective optimization leads to local optimum are avoided, and better economical efficiency is achieved; correlation between the indices is taken into consideration while considering the degree of variability of the evaluation indices, and better objectiveness and scientificity are achieved;
2. according to the method, the gas pipeline network can be effectively monitored, and monitoring nodes of pressure sensor monitoring points are clarified, which is beneficial to determining a range of abnormal pressure monitoring data; and
3. according to the method, the current actual operating condition of the gas pipeline network is considered, cost and monitoring efficiency are taken into consideration, arrangement positions and priorities of pressure sensors during renovation and reconstruction of an old urban gas pipeline network can be provided, and a reference is provided for renovation and reconstruction of pressure monitoring devices by a gas company, thereby improving safety of the urban gas pipeline network.

### BRIEF DESCRIPTION OF THE DRAWINGS

Drawings of the specification constituting a part of the present disclosure are described for further understanding the present disclosure. Schematic embodiments of the present disclosure and descriptions thereof are schematic of the present disclosure, and are not intended to limit the present disclosure.

FIG. 1 is a flowchart of an optimization method for arrangement of pressure sensors in an urban gas pipeline network according to the present disclosure;

FIG. 2 is a schematic diagram of a topological relation of the gas pipeline network containing all nodes for optimization of arrangement of pressure sensors according to the present disclosure;

FIG. 3 is a schematic diagram of the gas pipeline network containing original pressure sensors for optimization of arrangement of pressure sensors according to the present disclosure;

FIG. 4 is a schematic diagram of the gas pipeline network after optimization of arrangement of pressure sensors according to the present disclosure; and

FIG. 5 is a schematic diagram of an optimization system for arrangement of pressure sensors in the urban gas pipeline network according to the present disclosure.

### DETAILED DESCRIPTION OF THE PRESENT DISCLOSURE

It should be noted that the following detailed descriptions are exemplary, which are intended to further explain the present application. Unless otherwise indicated, all technical and scientific terms used herein have the same meaning as commonly understood by those ordinarily skilled in the prior art to which the present application pertains.

It should be noted that the terms used here are not intended to limit plural forms according to the present application, but are merely descriptive of the specific implementations. Besides, it should be also appreciated that, when the terms “comprise” and/or “include” are used in the specification, it is indicated that characteristics, steps, operations, devices, assemblies, and/or combinations thereof exist.

Additionally, any directional indication (such as upper, lower, left, right, front, back, or the like) involved in the embodiments of the present disclosure is only used for explaining relative position relations, movement conditions and the like of components in a certain specific posture (as shown in the drawings). If the specific posture changes, the directional indications may change accordingly.

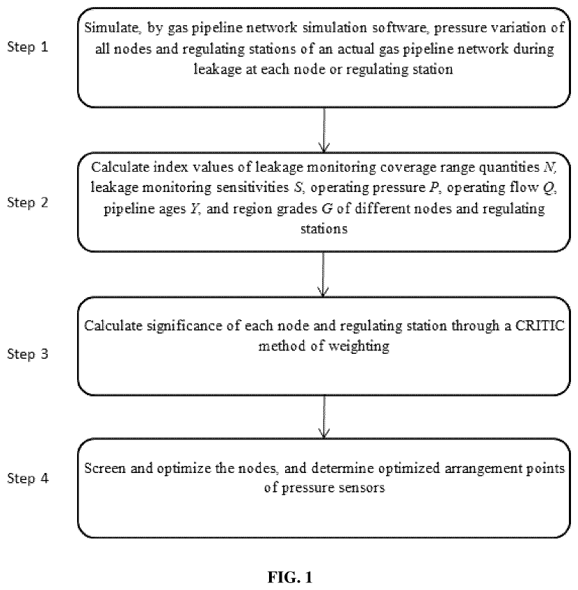

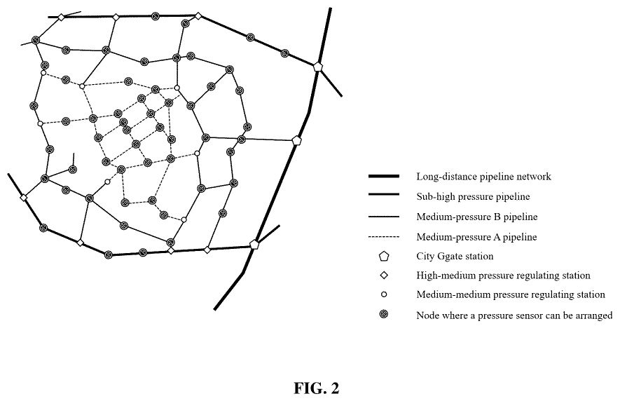

As shown in FIG. 1, an optimization method for arrangement of pressure sensors in an urban gas pipeline network according to the present disclosure includes the following steps:

step 1, n nodes (the nodes are intersections of pipelines in a structure of the urban gas pipeline network and intersections of gas transmission stations and the pipelines in the pipeline network) and regulating stations in the urban gas pipeline network are adopted as to-be-optimized points, numbered, and respectively named A1, A2, . . . , Ai, . . . , An; information of each pipeline in the urban gas pipeline network is input in gas pipeline network simulation software (such as Synergi Gas and Transient Gas Network), and operating pressure P and operating flow Q of each to-be-optimized point of the actual gas pipeline network under a normal operating condition are simulated and output; a leakage flow value ΔQ (ΔQ is usually not greater than 5% of the flow Q under the normal operating condition) is set at each to-be-optimized point, a self pressure variation value of each to-be-optimized point of the actual gas pipeline network during leakage and pressure variation values of other to-be-optimized points influenced by leakage are simulated and output, and recorded as [ΔP^{Ai}_{A1}, ΔP^{Ai}_{A2}, . . . , ΔP^{Ai}_{Ai}, ΔP^{Ai}_{Aj}, . . . , ΔP^{Ai}_{An}], where ΔP^{Ai}_{Ai} represents the self pressure variation value of the to-be-optimized point Aᵢ during leakage, and ΔP^{Ai}_{Aj} represents the pressure variation value of Aⱼ during leakage of the to-be-optimized point Aᵢ; the pressure variation values of all the to-be-optimized points are represented as a matrix [T]_{n×n} during leakage of each to-be-optimized point:

$$T = \{ \begin{matrix}Δ {P}_{A 1}^{A 1} & Δ {P}_{A 2}^{A 1} & … & Δ {P}_{A n}^{A 1} \\ Δ {P}_{A 1}^{A 2} & Δ {P}_{A 2}^{A 2} & … & Δ {P}_{A n}^{A 2} \\ … & … & … & … \\ Δ {P}_{A 1}^{A n} & Δ {P}_{A 2}^{A n} & … & Δ {P}_{A n}^{A n}\end{matrix} \} = \{ \begin{matrix}{t}_{11} & {t}_{12} & … & {t}_{1 n} \\ {t}_{21} & {t}_{22} & … & {t}_{2 n} \\ … & … & … & … \\ {t}_{n 1} & {t}_{n 2} & … & {t}_{n n}\end{matrix} \} ;$$

where tᵢⱼ is an element in an i^{th} row and a j^{th} column in the matrix [T]_{n×n}, tᵢⱼ=ΔP^{Ai}_{Aj}, and i, j=1, 2, 3, . . . , n.

According to parameter requirements of the gas pipeline network simulation software, the information of each pipeline in the urban gas pipeline network includes a pipeline diameter, length, operating pressure, topological relation of the pipeline network, pressure and flow of gate stations, pressure of the regulating stations, pressure and flow on a user side, etc.

Step 2: index values of a leakage monitoring coverage range quantity N, a leakage monitoring sensitivity S, operating pressure P, operating flow Q, a pipeline age Y, and a region grade G of each to-be-optimized point are calculated, specifically as follows:

S201: the leakage monitoring coverage range quantity N of each to-be-optimized point is calculated, where a solving process of N is as follows:
first step, a pressure influence coefficient matrix [Y]_{n×n} of leakage of each to-be-optimized point for other to-be-optimized points is calculated according to the matrix [T]_{n×n} in step 1, where a calculation formula for an element Y(i, j) in an i^{th} row and a j^{th} column in the pressure influence coefficient matrix [Y]_{n×n} is Y(i, j)=tⱼᵢ/tⱼⱼ=ΔP^{Aj}_{Ai}/ΔP^{Aj}_{Aj}; i=1, 2, 3, . . . , n, j=1, 2, 3, . . . , n, and n is a sum of the number of all the to-be-optimized points. An element of a vector in the i^{th} row in the matrix [Y]_{n×n} represents an influence degree to which the pressure of the to-be-optimized point Aᵢ is affected by the leakage of other to-be-optimized points; and an element of a vector in the j^{th} column represents an influence degree to which the pressure of other to-be-optimized points is affected by the leakage of the to-be-optimized point Aⱼ.

Second step, a standard deviation of each element in a k^{th} column in the matrix [Y]_{n×n} is standardized through a standard deviation standardizing method, to obtain a pressure influence standard matrix [Y′]_{n×n}, where a calculation formula is:

$${Y}^{′} ( i , k ) = \frac{Y ( i , k ) - \overline{{Y}_{k}}}{{S}_{k}} [ ( i , k = 1 , 2 , 3 , … , n )$$

In the formula, Y′(i, k) is an element in an i^{th} row and a k^{th} column in the matrix [Y′]_{n×n}, Y̅ₖ is a mean of an element Y(i, k) in the k^{th} column in [Y]_{n×n}, and

$${\overline{Y}}_{k} = \frac{1}{n} {\sum }_{i = 1}^{n} Y ( i , k ) ;$$

and Sₖ is a standard deviation of the element Y(i, k) in the k^{th} column in [Y]_{n×n}, and

$${S}_{k} = \sqrt{\frac{1}{n} {\sum }_{i = 1}^{n} {( Y ( i , k ) - {\overline{Y}}_{k} )}^{2}} .$$

Third step, extreme values of elements in each column in the matrix [Y′]_{n×n} are standardized through an extreme value standardizing method, to obtain a pressure influence extreme value standard matrix [Y″]_{n×n}, where a calculation formula is:

$${Y}^{″} ( i , k ) = \frac{{Y}^{′} ( i , k ) - {Y}_{k , min}^{′}}{{Y}_{k , max}^{{}^{′} k , {min}^{′}}}$$

In the formula, Y″(i, k) is an element in an i^{th} row and a k^{th} column in the matrix [Y″]_{n×n}, Y′_{k,min} is a minimum element in elements in the k^{th} column in [Y′]_{n×n}, and Y′_{k,max} is a maximum element in the elements in the k^{th} column in [Y′]_{n×n}.

Fourth step, the matrix [Y″]_{n×n} is calculated through a Euclidean distance method, to obtain a leakage pressure influence fuzzy similar matrix [R]_{n×n}, where a calculation formula is:

$${r}_{ij} = \sqrt{\frac{1}{n} {\sum }_{k = 1}^{n} {( {Y}^{″} ( i , k ) - {Y}^{″} ( j , k ) )}^{2}}$$

In the formula, rᵢⱼ is an element in an i^{th} row and a j^{th} column in the leakage pressure influence fuzzy similar matrix [R]_{n×n}, and i, j=1, 2, 3, . . . , n; the magnitude of rᵢⱼ reflects a similarity between elements in an i^{th} row in the matrix [Y″]_{n×n} and elements in a j^{th} column in the matrix [Y″]_{n×n}, namely pressure correlation between the to-be-optimized points Aᵢ and Aⱼ; and Y″(i, k) is the element in the i^{th} row and the k^{th} column in the matrix [Y″]_{n×n}, and Y″(j, k) is an element in a j^{th} row and the k^{th} column in the matrix [Y′]_{n×n}.

Fifth step, a pressure correlation distance constraint value μ of the to-be-optimized points is set, all elements in [R]_{n×n} and the correlation distance constraint value μ are compared, in a case that the element rᵢⱼ in [R]_{n×n} is less than or equal to μ, the element is converted into 1, otherwise the element is converted into 0; and the leakage pressure influence fuzzy similar matrix [R]_{n×n} is converted into a Boolean matrix [r]_{n×n}; where μ is greater than 0 and less than 1.

The constraint value μ is adopted as a constraint condition for optimized selection of pressure monitoring points, it is indicated that pressure correlation between the to-be-optimized points is large enough in a case that rᵢⱼ is less than the constraint value μ, and the two to-be-optimized points and nodes can be mutually monitored.

Sixth step, the Boolean matrix [r]_{n×n} is summed row by row, to obtain the leakage monitoring coverage range quantity N of each to-be-optimized point as a pressure monitoring point.

S202: the leakage monitoring sensitivity S of each to-be-optimized point is calculated.

An element Y″(i, j) in the pressure influence extreme value standard matrix [Y″]_{n×n} and a corresponding element r(i, j) in the Boolean matrix [r]_{n×n} are multiplied, to obtain a matrix [S]_{n×n}, where S(i, j) is an element in an i^{th} row and a j^{th} column in the matrix [S]_{n×n}, S(i, j)=Y″(i, j)×r(i, j), and i, j=1, 2, 3, . . . , n, and the matrix [S]_{n×n} is summed row by row, to obtain the leakage monitoring sensitivities S of different to-be-optimized points as pressure monitoring points.

S203: the operating pressure P of each to-be-optimized point under the normal operating condition output in step 1 is read.

S204: the operating flow Q of each to-be-optimized point under the normal operating condition output in step 1 is read.

S205: a pipeline age Y of a pipeline where each to-be-optimized point is located is determined.

The pipeline age is determined according to installation duration of the pipeline where the to-be-optimized point is located, with year as unit, which can be obtained through a gas company pipeline installation completion acceptance record or a gas information management platform.

S206: a region grade G of the pipeline where each to-be-optimized point is located is determined, and G is set as 1, 2, 3 and 4 in a case of a first-grade region, a second-grade region, a third-grade region and a fourth-grade region respectively.

The region grade G of the pipeline where each to-be-optimized point is located is determined according to a method for grading urban gas pipeline regions in GB 50028-2006 “Code for Design of City Gas Engineering (2020)” through a gas pipeline network geographic information system (GIS), the gas information management platform or manual inspection, and G is set as 1, 2, 3 and 4 in the case of the first-grade region, the second-grade region, the third-grade region and the fourth-grade region respectively.

Step 3, significance of each to-be-optimized point is calculated through a CRITIC method of weighting.

The CRITIC method of weighting may refer to “Diakoulaki, D., Mavrotas, G., & Papayannakis, L. (1995). Determining objective weights in multiple criteria problems: The critic method. Computers & Operations Research, 22(7), 763-770.”. The CRITIC method of weighting may specifically include the following steps:

S301: a matrix X=[x_{pq}]_{n×6} is formed by six evaluation index values B_{1×q}=B_{1×6}=[N, S, P, Q, Y, G] of all the to-be-optimized points, where x_{pq} is an element in a p^{th} row and a q^{th} column in the matrix, which represents the value of an evaluation index B_{q} of a to-be-optimized point Aₚ, p=1, 2, 3, . . . , n, and n is the number of all the to-be-optimized points; and q=1, 2, 3, . . . , 6. The matrix X is shown as follows:

$$X = \{ \begin{matrix}{x}_{11} & {x}_{12} & … & {x}_{16} \\ {x}_{21} & {x}_{22} & … & {x}_{26} \\ … & … & … & … \\ {x}_{n 1} & {x}_{22} & … & {x}_{n 6}\end{matrix} \} .$$

S302: the operating pressure P and the operating flow Q under the normal operating condition are defined as negative indices, the leakage monitoring coverage range quantity N, the leakage monitoring sensitivity S, the pipeline age Y, and the region grade G are defined as positive indices, positive index columns and negative index columns in the matrix X are standardized respectively, to obtain X′=[x′_{pq}]_{n×6}, where x′_{pq} is an element in the matrix, which represents a standardized value of the evaluation index B_{q} of the to-be-optimized point Aₚ, and the matrix X′ is shown as follows:

$${X}^{′} = \{ \begin{matrix}{x}_{11}^{′} & {x}_{12}^{′} & … & {x}_{16}^{′} \\ {x}_{21}^{′} & {x}_{22} & … & {x}_{26}^{′} \\ … & … & … & … \\ {x}_{n 1}^{′} & {x}_{22}^{′} & … & {x}_{n 6}^{′}\end{matrix} \}$$

S303: variability of the evaluation indices is calculated and represented in a form of a standard deviation, and a formula is as follows:

$${σ}_{q} = \sqrt{\frac{{\sum }_{p = 1}^{n} ( {x}_{pq}^{′} - \overline{{x}_{q}^{′}} )}{n - 1}} ( p = 1 , 2 , 3 , … , n ; q = 1 , 2 , 3 , … , 6 )$$

In the formula, σ_{q} represents a standard deviation in a q^{th} column in the matrix X′, which reflects difference fluctuation of an element value of the evaluation index B_{q} corresponding to this column, the larger the standard deviation, the larger the value difference of the evaluation index, the higher the evaluation intensity of the evaluation index B_{q}, and the higher the variability, and therefore more weights should be assigned to this index. x̅′̅_̅{̅q̅}̅ is a mean of the q^{th} column in the matrix X′, and

$$\overline{{x}_{q}^{′}} = \frac{{\sum }_{p = 1}^{n} {x}_{pq}^{′}}{n} .$$

S304: conflict between the evaluation indices is calculated, which reflects the degree of correlation between different indices, in a case of significant positive correlation, the smaller the conflict value, the more the reflected same information, and the more repetitive the reflected evaluation content, and therefore the evaluation intensity of the index is reduced to a certain degree. The formula is as follows:

$${f}_{q} = {\sum }_{l = 1}^{6} ( 1 - {r}_{ql}^{′} ) ( q , l = 1 , 2 , 3 , … , 6 )$$

In the formula, f_{q} represents the magnitude of conflict between the evaluation index B_{q} and the other five evaluation indices Bₗ, r′_{ql} is a correlation coefficient between the evaluation index B_{q} and the evaluation indices Bₗ, and a Pearson's correlation coefficient is adopted.

S305: an information bearing capacity C_{q}=σ_{q}×f_{q} of the evaluation index is calculated.

S306: a weight of the evaluation index is calculated, where a formula is as follows:

$${W}_{q} = \frac{{C}_{q}}{{\sum }_{q = 1}^{6} {C}_{q}} ( q = 1 , 2 , 3 , … , 6 )$$

In the formula, W_{q} is a weight of the evaluation index B_{q}.

S307: a synthetic score Sₚ of each to-be-optimized point is calculated, Sₚ is adopted as significance of the to-be-optimized point Aₚ, and a formula is as follows:

$${S}_{p} = {\sum }_{q = 1}^{6} {W}_{q} {x}_{p q}^{′}$$

(p=1, 2, 3, . . . , n; q=1, 2, 3, . . . , 6)

Step 4, the points are screened and optimized, to obtain optimized arrangement points of the pressure sensors. The process is as follows:

S401: the significance Sₚ of all the to-be-optimized points in step 3 is sorted by magnitude, and then removing the regulating stations arranged in the to-be-optimized points, nodes where the pressure sensors have been arranged, and other to-be-optimized points that can be monitored by the original pressure sensor nodes and regulating stations arranged as arrangement points of the pressure sensors are removed from the sorting, to obtain nodes where the pressure sensors are to be arranged.

As an implementation of the present disclosure, the two to-be-optimized points can be mutually monitored according to the value between rᵢⱼ and the constraint value μ in step 201.

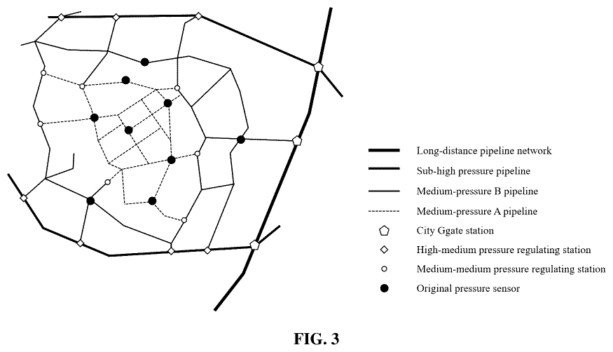

As shown in FIG. 3, FIG. 3 is a schematic diagram of a gas pipeline network containing original pressure sensors and regulating stations. Nodes of these original pressure sensors and regulating stations are firstly removed when pressure sensor arrangement points are added.

S402: the node with the maximum significance is selected from the nodes where the pressure sensors are to be arranged and used as the optimized arrangement point of the pressure sensor, and other to-be-optimized points that can be monitored by the optimized arrangement point are removed.

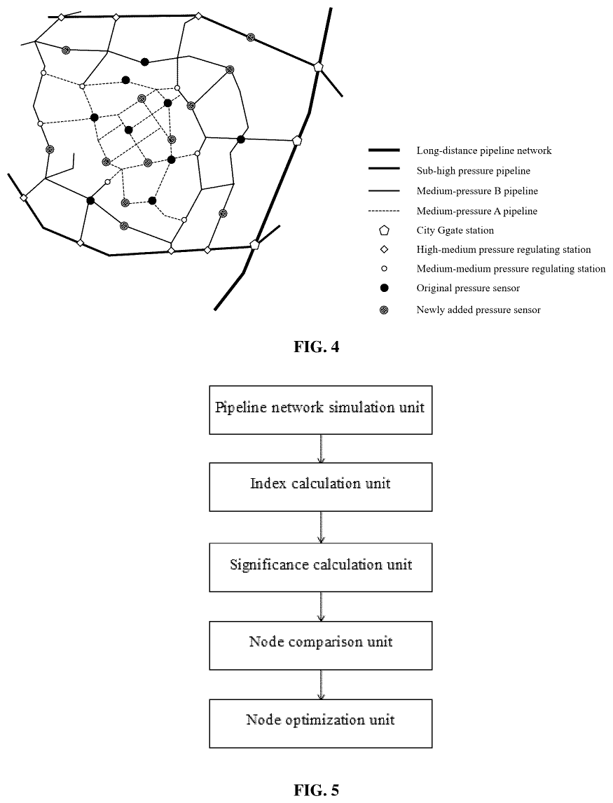

S403: step S402 is repeated until a node coverage rate C of the arrangement points of the pressure sensors meets preset requirements, as shown in FIG. 4, the final optimized arrangement points of the pressure sensors are obtained, where the node coverage rate C is a ratio of the number n_{c} of the optimized arrangement points of the pressure sensors to the number n of the to-be-optimized points.

As shown in FIG. 5, the present disclosure further provides an optimization system for arrangement of pressure sensors in an urban gas pipeline network according to the present disclosure, including:

a pipeline network simulation unit configured to simulate pressure P and flow Q of each to-be-optimized point of the actual gas pipeline network under a normal working condition; and set a leakage flow value at each to-be-optimized point, and simulate and output a self pressure variation value of each to-be-optimized point of the actual gas pipeline network during leakage and pressure variation values of other nodes and regulating stations influenced by leakage;

an index calculation unit configured to calculate index values of a leakage monitoring coverage range quantity N, a leakage monitoring sensitivity S, operating pressure P, operating flow Q, a pipeline age Y, and a region grade G of each to-be-optimized point;

a significance calculation unit configured to calculate significance of each to-be-optimized point through a CRITIC method of weighting; and

node comparison and optimization units configured to sort according to degrees of significance of the to-be-optimized points, screen and optimize the points, and output optimized arrangement points of the pressure sensors.

The above descriptions are only preferred embodiments of the present application, and are not intended to limit the present application. For those skilled in the art, the present application may have various modifications and variations. Any modification, equivalent replacement, improvement, etc. made within the spirit and principle of the present application shall fall within the scope of protection of the present application.

1. An optimization method for arrangement of pressure sensors in an urban gas pipeline network, comprising following steps:
step 1, adopting n nodes and regulating stations in the urban gas pipeline network as to-be-optimized points, respectively numbering and naming the same as A₁, A₂, . . . , Aᵢ, . . . , Aₙ; inputting information of each pipeline in the urban gas pipeline network in a gas pipeline network simulation software, and simulating and outputting operating pressure P and operating flow Q of each to-be-optimized point of the actual gas pipeline network under a normal operating condition; setting a leakage flow value ΔQ at each to-be-optimized point, simulating and outputting a self pressure variation value of each to-be-optimized point of the actual gas pipeline network during leakage and pressure variation values of other to-be-optimized points influenced by leakage, and recording as [ΔP^{Ai}_{A1}, ΔP^{Ai}_{A2}, . . . , ΔP^{Ai}_{Ai}, ΔP^{Ai}_{Aj}, . . . , ΔP^{Ai}_{An}], where ΔP^{Ai}_{Ai} represents the self pressure variation value of the to-be-optimized point Aᵢ during leakage, and ΔP^{Ai}_{Aj} represents the pressure variation value of Aⱼ during leakage of the to-be-optimized point Aᵢ; representing the pressure variation values of all the to-be-optimized points as a matrix [T]_{n×n} during leakage of each to-be-optimized point:
$$T = \{ \begin{matrix}Δ {P}_{A 1}^{A 1} & Δ {P}_{A 2}^{A 1} & … & Δ {P}_{An}^{A 1} \\ Δ {P}_{A 1}^{A 2} & Δ {P}_{A 2}^{A 2} & … & Δ {P}_{An}^{A 2} \\ … & … & … & … \\ Δ {P}_{A 1}^{An} & Δ {P}_{A 2}^{An} & … & Δ {P}_{An}^{An}\end{matrix} \} = \{ \begin{matrix}{t}_{11} & {t}_{12} & … & {t}_{1 n} \\ {t}_{21} & {t}_{22} & … & {t}_{2 n} \\ … & … & … & … \\ {t}_{n 1} & {t}_{n 2} & … & {t}_{nn}\end{matrix} \} ;$$
where tᵢⱼ is an element in an i^{th} row and a j^{th} column in the matrix [T]_{n×n}, tᵢⱼ=ΔP^{Ai}_{Aj}, and i, j=1, 2, 3, . . . , n;
step 2: calculating index values of a leakage monitoring coverage range quantity N, a leakage monitoring sensitivity S, operating pressure P, operating flow Q, a pipeline age Y, and a region grade G of each to-be-optimized point, specifically as follows:
S201: calculating the leakage monitoring coverage range quantity N of each to-be-optimized point, where a solving process of the leakage monitoring coverage range quantity Nis as follows:
firstly, calculating a pressure influence coefficient matrix [Y]_{n×n} of leakage of each to-be-optimized point for other to-be-optimized points according to the matrix [T]_{n×n} in step 1, where a calculation formula for an element Y(i, j) in an i^{th} row and a j^{th} column in the pressure influence coefficient matrix [Y]_{n×n} is Y(i, j)=tⱼᵢ/tⱼⱼ=ΔP^{Aj}_{Ai}/ΔP^{Aj}_{Aj}; i=1, 2, 3, . . . , n, j=1, 2, 3, . . . , n, and n is the number of all the to-be-optimized points; an element of a vector in the i^{th} row in the matrix [Y]_{n×n} represents an influence degree to which the pressure of the to-be-optimized point Aᵢ is affected by the leakage of other to-be-optimized points; and an element of a vector in the j^{th} column represents an influence degree to which the pressure of other to-be-optimized points is affected by the leakage of the to-be-optimized point Aⱼ;
secondly, standardizing a standard deviation of each element in a k^{th} column in the matrix [Y]_{n×n} through a standard deviation standardizing method, to obtain a pressure influence standard matrix [Y′]_{n×n};
thirdly, standardizing extreme values of elements in each column in the matrix [Y′]_{n×n} through an extreme value standardizing method, to obtain a pressure influence extreme value standard matrix [Y″]_{n×n};
fourthly, calculating the matrix [Y″]_{n×n} through a Euclidean distance method, to obtain a leakage pressure influence fuzzy similar matrix [R]_{n×n};
fifthly, setting a pressure correlation distance constraint value μ of the to-be-optimized points, comparing all elements in [R]_{n×n} and the correlation distance constraint value μ, in a case that an element rᵢⱼ in [R]_{n×n} is less than or equal to μ, converting the element into 1, otherwise, converting the element into 0; converting the leakage pressure influence fuzzy similar matrix [R]_{n×n} into a Boolean matrix [r]_{n×n}; where μ is greater than 0 and less than 1; rᵢⱼ is an element in an i^{th} row and a j^{th} column of the leakage pressure influence fuzzy similar matrix [R]_{n×n}, and i, j=1, 2, 3, . . . , n; the magnitude of rᵢⱼ reflects a similarity between elements in an i^{th} row in the matrix [Y″]_{n×n} and elements in a j^{th} column in the matrix [Y″]_{n×n}, namely pressure correlation between the to-be-optimized points Aᵢ and Aⱼ;
sixthly, summing the Boolean matrix [r]_{n×n} row by row, to obtain the leakage monitoring coverage range quantity N of each to-be-optimized point as a pressure monitoring point;
S202: calculating the leakage monitoring sensitivity S of each to-be-optimized point;
multiplying an element Y″(i, j) in the pressure influence extreme value standard matrix [Y″]_{n×n} and a corresponding element r(i, j) in the Boolean matrix [r]_{n×n}, to obtain a matrix [S]_{n×n}, and summing the matrix [S]_{n×n} row by row, to obtain the leakage monitoring sensitivities S of to-be-optimized points as pressure monitoring points;
S203: reading the operating pressure P of each to-be-optimized point under the normal operating condition output in step 1;
S204: reading the operating flow Q of each to-be-optimized point under the normal operating condition output in step 1;
S205: determining a pipeline age Y of a pipeline where each to-be-optimized point is located through a gas company pipeline installation completion acceptance record or a gas information management platform;
S206: determining a region grade G of the pipeline where each to-be-optimized point is located through a gas pipeline network geographic information system, the gas information management platform or manual inspection, and setting G as 1, 2, 3 and 4 in a case of a first-grade region, a second-grade region, a third-grade region and a fourth-grade region respectively;
step 3, calculating significance of each to-be-optimized point through a CRITIC method of weighting; and
step 4, screening and optimizing the to-be-optimized points, to obtain optimized arrangement points of the pressure sensors.

2. The optimization method for arrangement of pressure sensors in an urban gas pipeline network according to claim 1, wherein the step 3 specifically comprises:
S301: forming a matrix X=[x_{pq}]_{n×6} by six evaluation index values B_{1×q}=B_{1×6}=[N, S, P, Q, Y, G] of all the to-be-optimized points, where x_{pq} is an element in a p^{th} row and a q^{th} column in the matrix, which represents the value of an evaluation index B_{q} of a to-be-optimized point Aₚ, p=1, 2, 3, . . . , n, and n is the number of all the to-be-optimized points; and q=1, 2, 3, . . . , 6;
S302: defining the operating pressure P and the operating flow Q under the normal operating condition as negative indices, defining the leakage monitoring coverage range quantity N, the leakage monitoring sensitivity S, the pipeline age Y, and the region grade G as positive indices, respectively standardizing positive index columns and negative index columns in the matrix X to obtain X′=[x′_{pq}]_{n×6}, where x′_{pq} is an element in the matrix, which represents a standardized value of the evaluation index B_{q} of the to-be-optimized point Aₚ;
S303: calculating variability of the evaluation indices, which is represented in a form of a standard deviation, and a formula is as follows:
$${σ}_{q} = \sqrt{\frac{{\sum }_{p = 1}^{n} ( {x}_{pq}^{′} - \overline{{x}_{q}^{′}} )}{n - 1}} ( p = 1 , 2 , 3 , … , n ; q = 1 , 2 , 3 , … , 6 ) ;$$
in the formula, σ_{q} represents a standard deviation in a q^{th} column in the matrix X, x̅′̅_̅{̅q̅}̅ is a mean of the q^{th} column in the matrix X, and
$$\overline{{x}_{q}^{′}} = \frac{{\sum }_{p = 1}^{n} {x}_{pq}^{′}}{n} ;$$
S304: calculating conflict between the evaluation indices, the formula is as follows:
$${f}_{q} = {\sum }_{l = 1}^{6} ( 1 - {r}_{ql}^{′} ) ( q , l = 1 , 2 , 3 , … , 6 )$$
wherein, f_{q} represents the magnitude of conflict between the evaluation index B_{q} and the other five evaluation indices Bₗ, r′_{ql} is a correlation coefficient between the evaluation index B_{q} and the evaluation indices Bₗ, and a Pearson's correlation coefficient is adopted;
S305: calculating an information bearing capacity C_{q}=σ_{q}×f_{q} of the evaluation index;
S306: calculating a weight of the evaluation index, where a formula is as follows:
$${W}_{q} = \frac{{C}_{q}}{{\sum }_{q = 1}^{6} {C}_{q}} ( q = 1 , 2 , 3 , … , 6 )$$
in the formula, W_{q} is a weight of the evaluation index B_{q};
S307: calculating a synthetic score Sₚ of each to-be-optimized point, taking the synthetic score Sₚ as significance of the to-be-optimized point Aₚ, and a formula is as follows:
$${S}_{p} = {\sum }_{q = 1}^{6} {W}_{q} {x}_{pq}^{′} ( p = 1 , 2 , 3 , … , n ; q = 1 , 2 , 3 , … , 6 ) .$$

3. The optimization method for arrangement of pressure sensors in an urban gas pipeline network according to claim 1, wherein the step 4 specifically comprises:
S401: sorting the significance Sₚ of all the to-be-optimized points in step 3, and removing the regulating stations arranged in the to-be-optimized points, nodes where the pressure sensors have been arranged, and other to-be-optimized points that can be monitored by the original pressure sensor nodes and regulating stations arranged as arrangement points of the pressure sensors from the sorting, to obtain nodes where the pressure sensors are to be arranged;
S402: selecting the node with the maximum significance from the nodes where the pressure sensors are to be arranged, taking the selected nodes as the optimized arrangement point of the pressure sensor, and removing other to-be-optimized points that can be monitored by the optimized arrangement point;
S403: repeatedly performing step S402 until a node coverage rate C of the arrangement points of the pressure sensors meets preset requirements, to obtain the final optimized arrangement points of the pressure sensors, where the node coverage rate C is a ratio of the number n_{c} of the optimized arrangement points of the pressure sensors to the number n of the to-be-optimized points.

4. The optimization method for arrangement of pressure sensors in an urban gas pipeline network according to claim 3, wherein determining whether two to-be-optimized points in S401 can be mutually monitored is based on the value between rᵢⱼ and the constraint value μ in step 2.

5. An optimization system for arrangement of pressure sensors in an urban gas pipeline network, applied to the optimization method according to claim 1, comprising following units:
a pipeline network simulation unit configured to simulate pressure and flow of each to-be-optimized point of the actual gas pipeline network under a normal working condition;
and set a leakage flow value at each to-be-optimized point, and simulate and output a self pressure variation value of each to-be-optimized point of the actual gas pipeline network during leakage and pressure variation values of other nodes and regulating stations influenced by leakage;
an index calculation unit configured to calculate index values of a leakage monitoring coverage range quantity N, a leakage monitoring sensitivity S, operating pressure P, operating flow Q, a pipeline age Y, and a region grade G of each to-be-optimized point;
a significance calculation unit configured to calculate significance of each to-be-optimized point through a CRITIC method of weighting; and
node comparison and optimization units configured to sort according to degrees of significance of the to-be-optimized points, screen and optimize the to-be-optimized points, and output optimized arrangement points of the pressure sensors.

6. The optimization method for arrangement of pressure sensors in an urban gas pipeline network according to claim 2, wherein the step 4 specifically comprises:
S401: sorting the significance Sₚ of all the to-be-optimized points in step 3, and removing the regulating stations arranged in the to-be-optimized points, nodes where the pressure sensors have been arranged, and other to-be-optimized points that can be monitored by the original pressure sensor nodes and regulating stations arranged as arrangement points of the pressure sensors from the sorting, to obtain nodes where the pressure sensors are to be arranged;
S402: selecting the node with the maximum significance from the nodes where the pressure sensors are to be arranged, taking the selected nodes as the optimized arrangement point of the pressure sensor, and removing other to-be-optimized points that can be monitored by the optimized arrangement point;
S403: repeatedly performing step S402 until a node coverage rate C of the arrangement points of the pressure sensors meets preset requirements, to obtain the final optimized arrangement points of the pressure sensors, where the node coverage rate C is a ratio of the number n_{c} of the optimized arrangement points of the pressure sensors to the number n of the to-be-optimized points.
